(19) United States
(12) Patent Application Publication
(10) Pub. No.: US 2007/0017068 A1
(43) Pub. Date: Jan. 25, 2007

(54) CLIP FOR SHEET-LIKE ARTICLES

(76) Inventor: Huang-Lin Wang, Fengshan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/162,387

(22) Filed: Sep. 8, 2005

(30) Foreign Application Priority Data
Jul. 22, 2005 (TW) 094124834

(51) Int. Cl. B42F 1/02

(52) U.S. Cl. 24/67.9

(57) ABSTRACT

A clip for sheet-like articles includes a first clipping section on a first end thereof, a second clipping section on a second end thereof, and a flexible bend between the first clipping section and the second clipping section. The first clipping section and the second clipping section cross and overlap each other at an intersection. When in use, the flexible bend holds an end edge of a plurality of stacked sheets, with the first clipping section and the second clipping section respectively clipping two opposite sides of the stacked sheets, thereby maintaining the stacked sheets in the stacked state.

### FIELD OF THE INVENTION

The present invention relates to a clip. In particular, the present invention relates to a clip for sheet-like articles.

### BACKGROUND OF THE INVENTION

FIG. 1 of the drawings illustrates a conventional paper clip 10 comprising a first end 101, a second end 102, three bends 11, 12, and 13, and four legs (not labeled). When using the paper clip 10 to clip a plurality of stacked sheet-like articles such as a plurality of pieces of paper, two of the legs and one of the bends 11, 12, and 13 elastically clip a side of the stacked sheets whereas the remaining legs and bends elastically clip the other side of the stacked sheets. The sheets are thus maintained in the stacked state.

The profit of the paper clip 10 is relatively low on current markets while the manufacture of the paper clip 10 requires at least three bending procedures. It is therefore an important subject to the manufacturers to cut the manufacturing cost for obtaining higher profit.

### OBJECTS OF THE INVENTION

An object of the present invention is to provide a clip for sheet-like articles that has a simple structure and thus can be manufactured at a low cost.

Another object of the present invention is to provide a clip for sheet-like articles that has a simple structure while providing a reliable clipping effect.

A further object of the present invention is to provide a clip for sheet-like articles with a rough face for enhancing the clipping effect.

Still another object of the present invention is to provide a clip for sheet-like articles that can be connected to another clip when desired, providing a more reliable clipping effect.

### SUMMARY OF THE INVENTION

A clip for sheet-like articles in accordance with the present invention comprises a first clipping section on a first end thereof, a second clipping section on a second end thereof, and a flexible bend between the first clipping section and the second clipping section. The first clipping section and the second clipping section cross and overlap each other at an intersection. When in use, the flexible bend holds an end edge of a plurality of stacked sheets, with the first clipping section and the second clipping section respectively clipping two opposite sides of the stacked sheets, thereby maintaining the stacked sheets in the stacked state.

Each of the first clipping section and the second clipping section may have an enlarged distal end.

At least one of the first clipping section and the second clipping section may comprise a rough face. Preferably, the rough face extends throughout a length of the clip.

The first end of the clip may comprise a socket for coupling with a second end of another clip.

The flexible bend may be circular, arcuate, drop-like, triangular, U-shaped, polygonal, or flowery.

Each of the first clipping section and the second clipping section may be arcuate, rectilinear, N-shaped, or S-shaped.

Other objects, advantages and novel features of this invention will become more apparent from the following detailed description when taken in conjunction with the accompanying drawings.

### BRIEF DESCRIPTION OF THE DRAWINGS

FIG. 1 is a plan view of a conventional paper clip;

FIG. 2 is a plan view of a first embodiment of a clip for sheet-like articles in accordance with the present invention;

FIG. 3 is a schematic view illustrating use of the clip for sheet-like articles in accordance with the present invention;

FIG. 4 is a plan view of a modified embodiment of the clip for sheet-like articles in accordance with the present invention;

FIG. 5 is a plan view of another modified embodiment of the clip for sheet-like articles in accordance with the present invention;

FIG. 6 is a plan view of a further modified embodiment of the clip for sheet-like articles in accordance with the present invention;

FIG. 7 is a plan view of still another modified embodiment of the clip for sheet-like articles in accordance with the present invention;

FIG. 8 is a plan view of yet another modified embodiment of the clip for sheet-like articles in accordance with the present invention; and

FIG. 9 is a plan view of still another modified embodiment of the clip for sheet-like articles in accordance with the present invention.

### DETAILED DESCRIPTION OF THE PREFERRED EMBODIMENTS

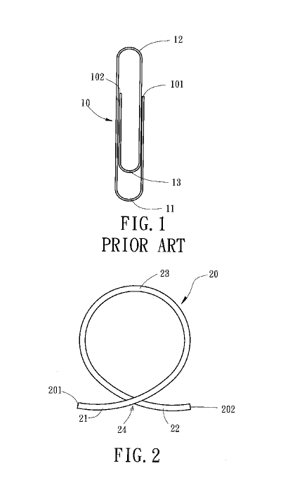

Referring to FIG. 2, a first embodiment of a clip 20 for sheet-like articles (such as pieces of paper) in accordance with the present invention comprises a first end 201, a second end 202, a first clipping section 21, a second clipping section 22, and a flexible bend 23.

The first clipping section 21 is substantially arcuate and adjacent to the first end 201. The second clipping section 22 is substantially arcuate and adjacent to the second end 202. The first clipping section 21 and the second clipping section 22 cross each other at an intersection 24. Namely, the first clipping section and the second section 22 overlap each other at the intersection 24. The flexible bend 23 extends between the first clipping section 21 and the second clipping section 22. The flexible bend 23 may be circular, arcuate or drop-like. The clip 20 is flexible and elastic itself. Thus, the first clipping section 21 and the second clipping section 22 can be maintained in the arcuate overlapped relationship at the intersection 24.

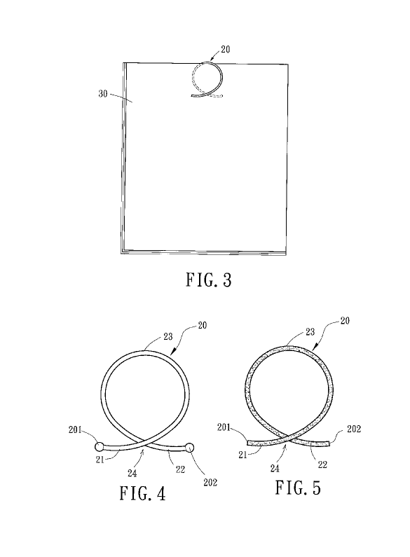

Referring to FIG. 3, when using the clip 20 to clip a plurality of stacked sheet-like articles 30 (hereinafter referred to as stacked sheets) such as a plurality of pieces of paper, the flexible bend 23 is attached to and thus holds an edge of the stacked sheets 30, with the first clipping section 21 elastically clipping a side of the stacked sheets 30 and with the second clipping section 22 elastically clipping the other side of the stacked sheets 30. Thus, a reliable clipping effect is provided by the clip 20 in accordance with the present invention that has a simple structure and that can be formed by a single bending procedure. The manufacturing cost of the clip 20 is thus relatively low.

Each of the first end 201 and the second end 202 of the clip 20 may be enlarged to prevent the stacked sheets 30 from disengaging from the clip 20. The first and second ends 201 and 202 may be spherical, as shown in FIG. 4. The clipping effect is thus improved. In an alternative arrangement, the first end 201 and the second end 202 of the clip 20 are flat.

FIG. 5 illustrates another modified embodiment of the invention, wherein at least one of the first clipping section 21 and the second clipping section 22 includes a rough face to prevent the stacked sheets from disengaging from the clip 20, further enhancing the clipping effect. Preferably, the rough face extends throughout the whole length of the clip 20.

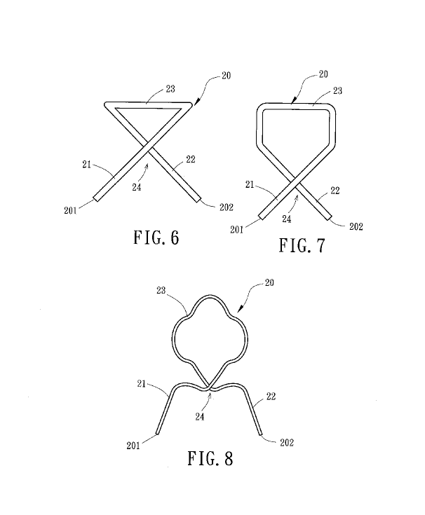

FIG. 6 illustrates a further modified embodiment of the invention, wherein the first and second clipping sections 21 and 22 are rectilinear and the flexible bend 23 is substantially triangular. The contact area between the flexible bend 23 and the stacked sheets 30 is increased. Thus, the flexible bend 23 can be more reliably attached to the edge of the stacked sheets 30.

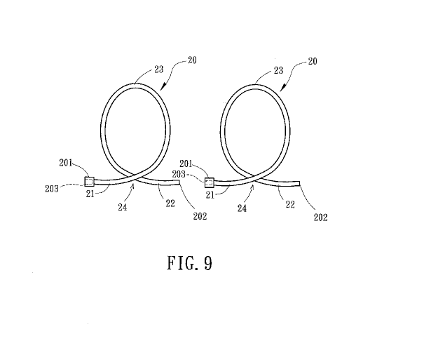

FIG. 7 illustrates still another modified embodiment of the invention, wherein the first and second clipping sections 21 and 22 are rectilinear and the flexible bend 23 is substantially U-shaped. Of course, the flexible bend 23 may be polygonal. Similarly, the contact area between the flexible bend 23 and the stacked sheets 30 is increased. Thus, the flexible bend 23 can be more reliably attached to the edge of the stacked sheets 30.

FIG. 8 illustrates yet another modified embodiment of the invention, wherein the flexible bend 23 is substantially flowery and the first and second clipping sections 21 and 22 are substantially N-shaped or S-shaped. Similarly, the contact area between the flexible bend 23 and the stacked sheets 30 is increased. Thus, the flexible bend 23 can be more reliably attached to the edge of the stacked sheets 30.

FIG. 9 illustrates still another modified embodiment of the invention, wherein the first end 201 of the clip 20 includes a socket 203 into which the second end 202 of another clip 20 is insertable. Thus, a plurality of paper clips 20 can be connected in series. The clipping reliability is improved while providing flexible application.

As apparent from the foregoing, the clip 20 in accordance with the present invention has a simple structure and thus can be manufactured easily at a low cost while providing a reliable clipping effect.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A clip for sheet-like articles comprising a first clipping section on a first end thereof, a second clipping section on a second end thereof, and a flexible bend between the first clipping section and the second clipping section, the first clipping section and the second clipping section crossing and overlapping each other at an intersection, the flexible bend being adapted to hold an end edge of a plurality of stacked sheets, with the first clipping section and the second clipping section respectively clipping two opposite sides of the stacked sheets, thereby maintaining the stacked sheets in the stacked state.

2. The clip for sheet-like articles as claimed in claim 1, wherein each of the first clipping section and the second clipping section has an enlarged distal end.

3. The clip for sheet-like articles as claimed in claim 1, wherein at least one of the first clipping section and the second clipping section comprises a rough face.

4. The clip for sheet-like articles as claimed in claim 1, wherein the clip comprises a rough face throughout a length thereof.

5. The clip for sheet-like articles as claimed in claim 1, wherein the first end of the clip comprises a socket for coupling with a second end of another clip.

6. The clip for sheet-like articles as claimed in claim 1, wherein the flexible bend is one of circular, arcuate, drop-like, triangular, U-shaped, polygonal, and flowery.

7. The clip for sheet-like articles as claimed in claim 1, wherein each of the first clipping section and the second clipping section is one of arcuate, rectilinear, N-shaped, and S-shaped.
